(19) United States
(12) Patent Application Publication
(10) Pub. No.: US 2007/0192858 A1
(43) Pub. Date: Aug. 16, 2007

(54) Peer based network access control

(75) Inventor: Stacey C. Lum, Los Altos, CA (US)

Correspondence Address: CARR & FERRELL LLP, 2200 GENG ROAD, PALO ALTO, CA, 94303, US

(73) Assignee: InfoExpress, Inc.

(21) Appl. No.: 11/356,555

(22) Filed: Feb. 16, 2006

(51) Int. Cl. G06F 12/14

(52) U.S. Cl. 726/22

(57) ABSTRACT

Systems and methods of securing a computing network are described. Communication from unauthorized devices is prevented by defining one or more dynamic policy enforcement points (DPEPs) on a network segment and specifying one of these DPEPs as an active policy enforcement point (APEP). The APEP prevents communication from unauthorized devices by spoofing an ARP response. If an APEP becomes unavailable, another of the one or more DPEPs is automatically selected as a new APEP. Members of the one or more DPEPs may be non-dedicated devices configured as DPEPs by the addition of security software. The number of DPEPs and APEPs can automatically scale with the number of devices on the computing network.

### BACKGROUND

1. Field of the Invention

The invention is in the field of computing systems and more specifically in the field of network security.

2. Related Art

Network communication protocols include methods by which a device can send messages specifically addressed to other devices on a computing network. For example, in some network architectures communications are based on layer 2 protocol in which a MAC (Media Access Control) address is used to access physical devices on the network and a layer 3 protocol in which internet protocol addresses (e.g., Internet Protocol addresses, or the like, hereafter referred to as IP addresses) are used to access devices. Direct physical addressing using MAC address is typically used between devices on the same network segment, while IP addresses may be used between network segments or even between computing networks.

When communicating to another device by IP address, it is most efficient to direct communications to a specific MAC address rather than broadcasting communications to all devices on the segment. There are, therefore, protocols by which devices on the same network segment can exchange a MAC address associated with a particular IP address. One of these protocols is address resolution protocol, referred to as ARP. In ARP, a first device that wishes to communicate with a second device broadcasts an ARP request to all devices on the network segment. This request includes an IP address of the second device and the MAC address of the first device. The ARP request is detected by the second device, which responds with an ARP response. The ARP response includes both the MAC and IP address of the second device and is addressed to the MAC address of the first device. Once the devices have exchanged MAC addresses, they can communicate with each other using messages that are addressed directly to each other using these MAC addresses.

When devices communicate between network segments, a first step in the communication is between a device and a router or other relay device on the network segment. Communication between the device and the router is accomplished using address resolution protocol and MAC addresses as described above. It is then the router's responsibility to communicate the message to the appropriate network segment using an IP address. Thus, even when communicating to other parts of a computing network or to other computing networks, the first step in the communication typically involves finding the MAC address of a router.

It is desirable to provide security on computing networks. As described in U.S. patent application Ser. Nos. 11/227,679 and 10/949,179, a computing network can be secured by configuring routers, DNS servers or other network infrastructure devices to control communications between devices on the computing network. However, these techniques require the configuration of the network infrastructure devices. On large computing networks, this configuration can require considerable time and effort for setup and maintenance. There is, therefore, a need for improved systems and methods of providing network security.

### SUMMARY

The invention includes new systems and methods of managing security on a computing network. Access to devices on the computing network is subject to a security policy that may include security audits managed by a policy validation server, referred to herein as PVS. If a device has not satisfied requirements of the security policy, the device is considered an unauthorized device and may be prevented from communicating with one or more other devices on the computing network. In the invention, those parts of the network that have the ability to prevent or restrict communication from a device that has not satisfied the requirements of the security policy are referred to as dynamic policy enforcement points (DPEPs), although a DPEP does not activate this ability until it determines that certain conditions have been met.

DPEPs are optionally peers of other devices on the computer network for which the DPEPs provide security. For example, a DPEP can be a general purpose personal computer that limits access by unauthorized devices to other general purpose personal computers on the same network segment. Thus, some embodiments of the invention includes general purpose computing devices that act as network access control (NAC) policy enforcement points. This capability is achieved while, eliminating the need to configure and manage routers, switches, DHCP servers, and dedicated network equipment to provide NAC.

In various embodiments of the invention there is no need to change configurations for network access and forwarding devices (e.g. routers, switches) to support NAC, and no need to manage network access and forwarding devices to support NAC; ability to provide NAC on unmanaged network equipment (e.g. hubs or unmanaged switches). Further, in some embodiments there is no need to configure network access and forwarding devices to support NAC as endpoints move from one port to another. In typical embodiments, there is no need to require additional subnets, VLANs, router access control list filters, or additional router ports to support NAC.

In the invention, more than one computing device on the computing network, or even within a single network segment, may operate as a DPEP. Further, DPEPs may be established by the addition of software to computing devices on the computing network that were not previously configured as DPEPs. These computing devices may be servers, personal computers, or the like that were connected to the network for reasons other than network access control. In some embodiments, any general computing devices added to the computing network have the potential to become a DPEP.

Typically, at any given time, one or more DPEPs on a network segment have the responsibility for preventing or restricting communications to and from unauthorized devices. A DPEP which is currently responsible for restricting or preventing communications from unauthorized devices is referred to herein as an active policy enforcement point or APEP. Any DPEP may become an APEP when the DPEP determines that certain conditions have been met. For example, if a current APEP is a personal computer that becomes disconnected from the computing network, one of the other DPEPs may automatically detect this and become an APEP. The conversion of a DPEP to an APEP may be dependent on a number of factors. For example, in various embodiments, the DPEP must have passed a security audit, must have a security agent, must have up to date anti-virus software, must have an address within a certain range, must be on a white list, must be a server, or the like. Further, a DPEP may only become an APEP when there is an insufficient number of APEPs already on a network segment. When such factors are met, the activation of a DPEP to an APEP can be automatic. Because DPEPs can run on general computing devices, the APEP may be a non-dedicated device.

The APEP enforces a security policy by redirecting network communication (packets) to a packet forwarding component, referred to herein as a PFC. The redirection is accomplished by masquerading the PFC as the intended destination of the network packets. Packets that would normally have been received by the unauthorized device (or receive by a device the unauthorized device is communicating with) are instead received by the PFC. The redirection, thus, allows the PFC to prevent communications to or from an unauthorized device by dropping or forwarding the redirected packets.

In various embodiments, the redirection is accomplished using ARP messages (e.g., APR requests and APR responses). For example, redirection may be accomplished by sending ARP requests and responses to the unauthorized devices and devices that are communicating with the unauthorized device. Alternatively, redirection can be accomplished by sending responses to neighbor discovery protocol (NDP) requests in IP version 6, sending responses to DHCP requests, sending DNS answers in response to DNS queries, or the like. The APEP can be configured to: (i) monitor ARP requests directed to other devices and respond with ARP responses to redirect packets to the PFC, (ii) monitor NDP requests directed to other devices and respond to redirect packets to the PFC, (iii) monitor for DHCP requests and respond with a DHCP communication (ACK) that contains a gateway address of the PFC, (v) monitor for DNS queries and respond with DNS answers which contain the PFC address, or the like. In some embodiments, the PFC monitors received packets for DNS queries to obtain the address of an intended server, and the PFC falsely responds with DNS responses containing a new server address, causing the unauthorized device to direct future communications to the new server rather than to the intended server.

The PFC receives packets, forwards packets, modifies packets (e.g. Network Address Translation), and/or filters packets. Packets that are forwarded can be sent to a device for which they were originally intended, sent to another device, or blocked by dropping the packets. The PFC is optionally included in the APEP, a DPEP, a router, a bridge, or other network forwarding device. Alternatively, the PFC may be a standalone network forwarding device. In some embodiments, PFC is not configured to forward packets.

When redirecting network packets, intended to travel from a first device to a second device, to the PFC, the APEP sends an ARP message to the first device that falsely claims the MAC address of the PFC is associated with the IP address of the second device. The ARP message includes the MAC address of the PFC and IP address of the second device such that the first device is led to believe the MAC address of the PFC corresponds to the IP address of the second device. As a result, further packets sent by the first device to the second device's IP address will be sent to the MAC address of PFC, and thus, be received by the PFC rather than the second device. Further details of this process are discussed elsewhere herein.

Various embodiments of the invention include a computing network comprising a server configured to download logic to a non-dedicated, general purpose computing devices, the logic being configured to allow the general purpose computing device to operate as a DPEP, a PFC configured to receive packets sent by unauthorized devices or to receive packets sent to unauthorized devices, the PFC being further configured to modify, drop or forward the received packets, a first PVS configured to manage a security audit to determine whether a device is an unauthorized device by comparing a security policy to information about the device, and a first DPEP and a second DPEP on the same network segment, the first DPEP and second DPEP each being general purpose computing devices and being configured to function as an APEP, and to enforce the security policy responsive to the security audit by sending an ARP message to redirect communication, between an unauthorized device and an other device, to the PFC, the first DPEP and the second DPEP each including logic configured for repeatedly determining if either of the first DPEP and second DPEP is an APEP.

Various embodiments of the invention include a computing network comprising a server configured to download logic to a non-dedicated, general purpose computing devices, the logic being configured to allow the general purpose computing device to operate as a DPEP, a plurality of PFC configured to receive packets sent by unauthorized devices or to receive packets sent to unauthorized devices, the plurality of PFC being further configured to modify, drop or forward the received packets, a first DPEP, a second DPEP and a third DPEP on the same network segment, the first DPEP, second DPEP and third DPEP each configured to function as an APEP, and to enforce a security policy responsive to a security audit by sending an ARP message to redirect communication, between an unauthorized device and an other device, to the PFC, and a first PVS configured to manage the security audit to determine whether a device is an unauthorized device by comparing the security policy to information about the device, the first PVS being included in either the first DPEP or the second DPEP.

Various embodiments of the invention include a computing network comprising a server configured to download logic to a non-dedicated, general purpose computing devices, the logic being configured to allow the general purpose computing device to operate as a DPEP, a plurality of PFC configured to receive packets sent by unauthorized devices or to receive packets sent to unauthorized devices, the plurality of PFC being further configured to modify, drop or forward the received packets, a first DPEP, a second DPEP and a third DPEP on the same network segment, the first DPEP, second DPEP and third DPEP each configured to function as an APEP, and to enforce a security policy responsive to a security audit by sending an ARP message to redirect communication, between an unauthorized device and an other device, to the PFC, and a first PVS configured to manage the security audit to determine whether a device is an unauthorized device by comparing the security policy to information about the device, the first PVS being included in either the first DPEP or the second DPEP.

Various embodiments of the invention include a computing network comprising a server configured to download logic to a non-dedicated, general purpose computing devices, the logic being configured to allow the general purpose computing device to operate as a DPEP, a plurality of PFC configured to receive packets sent by unauthorized devices or to receive packets sent to unauthorized devices, the plurality of PFC being further configured to modify, drop or forward the received packets, a PVS configured to manage a security audit to determine whether a device is an unauthorized device by comparing a security policy to information about the device, a first DPEP and a second DPEP on the same network segment, the first DPEP and second DPEP each being general purpose computing devices and being configured to function as an APEP, and to enforce the security policy responsive to the security audit by sending an ARP message to redirect communication, between an unauthorized device and an other device, to the PFC, and a rule server configured to provide rules to the plurality of PFC for use in determining if a packet should be modified, dropped, or forwarded.

Various embodiments of the invention include a computing network comprising a first DPEP configured, when functioning as an APEP, to enforce a security policy responsive to the security audit by sending a false message to redirect communication, between an unauthorized device and an other device, to a PFC, the first DPEP including logic configured for use in periodically determining whether the first DPEP or the second DPEP is the APEP at any particular time, and a second DPEP configured to operate on the same network segment as the first DPEP and, when functioning as an APEP, to enforce the security policy responsive to the security audit by sending a false message to redirect communication, between an unauthorized device and an other device, to the PFC, the second DPEP including logic configured for use in periodically determining whether the first DPEP or the second DPEP is the APEP at any particular time.

Various embodiments of the invention include a computing network comprising a DPEP configured to enforce a security policy responsive to a security audit by sending a false message to redirect communication, between an unauthorized device and another device, to a PFC, and a hierarchical PVS including a central component and a local component, the local component being configured for maintaining a list for identifying local devices not subject to the security audit, the central component being configured for defining characteristics of a security policy.

Various embodiments of the invention include a DPEP comprising a network interface configured to connect to a network segment including one or more other DPEPs, logic configured to detect a first device on the network segment, logic configured to determine if the first device has passed a security audit, and logic configured to send an ARP message to a second device on the network segment if the first device has not passed the security audit, the ARP message including a MAC address of a PFC and falsely identifying the MAC address of the PFC as the MAC address of the first device.

Various embodiments of the invention include a DPEP comprising a network interface configured to connect to a network segment including one or more other DPEPs, logic configured to detect a first device on the network segment, logic configured to determine if the first device has passed a security audit, logic configured to send an ARP message periodically if the first device has not passed the security audit, the ARP message including a MAC address of a PFC and configured to redirect communication between the first device and a second device on the network segment, and logic configured to determine if the DPEP or one of the other DPEPs is a current APEP.

Various embodiments of the invention include a DPEP comprising a network interface configured to connect to a network segment including one or more other DPEPs, logic configured to detect an ARP request sent by a first device on the network segment and intended for a second device on the network segment, logic configured to determine if the first device has passed a security audit, and logic configured to send an ARP response to the first device in response to the ARP request if the first device has not passed the security audit, the ARP response including a MAC address of a PFC and falsely identifying the MAC address of the PFC as the MAC address of the second device on the network segment.

Various embodiments of the invention include a method comprising receiving at a first device an ARP request from a second device on a computing network, the ARP request being intended for a third device on the computing network, determining if the second device is authorized to access the third device, if the second device is not authorized to access the third device, sending an ARP response from the first device to the second device, the ARP response being configured to falsely indicate to the second device that the first device is the third device such that further communication from the second device to the third device will be directed from the second device to the first device.

Various embodiments of the invention include a method comprising, applying a security audit to a first device on a computing network, determining that the first device has passed the security audit, and downloading software to the first device responsive to the first device having passed the security audit, the software configured to allow the first device to operate as one of a plurality of DPEPs on the computing network, members of the plurality of DPEPs each being configured to operate as an APEP.

Various embodiments of the invention include a method comprising monitoring the presence of a first APEP on a computing network from one of a plurality of DPEPs, determining that the first APEP is no longer available, selecting one of the plurality of DPEPs to operate as a new APEP, and operating the selected one of the plurality of DPEPs as the new APEP.

Various embodiments of the invention include a computer readable media having stored thereupon computer code configured to enable systems of the invention or perform methods of the invention.

### BRIEF DESCRIPTION OF THE VARIOUS VIEWS OF THE DRAWING

FIGS. 1A and 1B each illustrate a secure computing network, according to various embodiments of the invention;

FIG. 2 illustrates a DPEP, according to various embodiments of the invention;

FIG. 3 illustrates a method of providing dynamic security to a computing network, according to various embodiments of the invention;

FIG. 4 illustrates another method of providing dynamic security to a computing network, according to various embodiments of the invention;

FIG. 5 illustrates a method of generating a DPEP, according to various embodiments of the invention; and

FIG. 6 illustrates a method of selecting an APEP, according to various embodiments of the invention.

### DETAILED DESCRIPTION

Glossary of Acronyms:

APEP, active policy enforcement point.

ARP, address resolution protocol.

DHCP, dynamic host configuration protocol.

DNS, domain name service.

DPEP, dynamic policy enforcement point.

IP, internet protocol.

IPSec IKE, IP Security Internet Key Exchange.

LAN, local area network.

LDAP, Lightweight Directory Access Protocol.

MAC, media access control.

MS, Microsoft.

MS NAP, Microsoft Network Access Protection.

NAC, network access control.

NDP neighbor discovery packet.

PFC, packet forwarding component.

PVS, policy validation server.

SSL/TLS, Secure Socket Layer/Transport Layer Security.

The invention includes one or more DPEPs configured to enforce a security policy on a computing network. This security policy includes limiting communications from devices that have not satisfied requirements of the security policy, e.g., unauthorized devices. The requirements of the security policy optionally include passing a security audit.

In some embodiments, the security policy is managed by one or more policy validation servers. A PVS comprises a set of rules, auditing logic, and acquisition logic to obtain audit data including device configuration, location, environment (e.g. information about other devices and network equipment on the same segment as device), operating parameters (e.g. CPU utilization), or the like. The PVS can be configured to, for example, perform a security audit by applying the rules using the auditing logic, against the audit data obtained from the acquisition logic. The acquisition logic may obtain audit data by scanning the device (e.g. network port scanning), making remote procedure calls (e.g. Windows instrumentation via WMI), collecting data from agents on the device or from other devices, etc), or performing various combinations of these methods. The PVS may also manage the selection of APEPs. The PVS may potentially run on any computing device capable of receiving the rules and audit data including the DPEP, APEP, PFC, third party server, or the like.

In some embodiments, the PVS contains rule acquisition logic to obtain updated rules from a rule server that provides the rules to the PVS. The rule acquisition logic can obtain updated rules from the rule server periodically, continuously, or when requested manually by an operator.

In some embodiments, multiple PVSs are used to provide redundancy in the event that the other PVS is disabled. When one PVS is disabled, the other PVS can provide security audits to ensure continued operation.

The computing network optionally includes one or more separate network segments. In some embodiments, it is desirable to include at least one DPEP on each secured network segment. However, a PVS may be configured to manage security on more than one network segment.

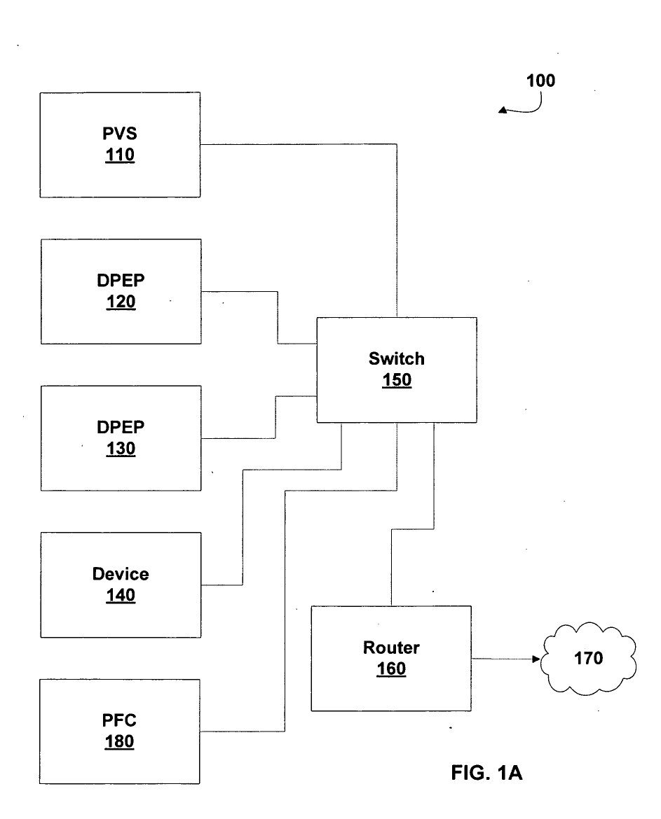

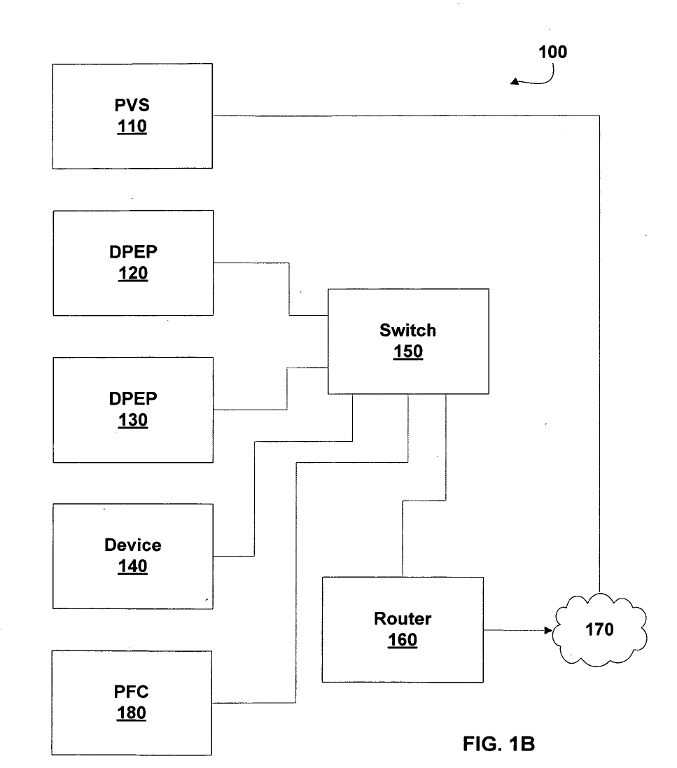

FIGS. 1A and 1B illustrate a Computing Network 100, according to various embodiments of the invention. Computing Network 100 typically includes servers, personal computers, communication devices, printers, storage devices, routers, switches, hubs, relays, or the like. Computing Network 100 optionally includes more than one network segments. Computing Network 100 optionally includes a communication network.

As illustrated in FIG. 1A, Computing Network 100 typically includes a Switch 150, at least one dynamic enforcement point, such as a DPEP 120 and/or a DPEP 130, an optional PVS 110, an optional other Device 140, an optional Router 160, an optional other Network Segments 170, and a PFC 180. Switch 150 may be a network switch, hub, bridge, or the like, through which devices communicate on a computing network. In some embodiments, those parts of Computing Network 100 directly connected to Switch 150 are on the same network segment and, thus, may communicate with each other via MAC addresses or the like.

DPEP 120 and DPEP 130 are each DPEPs configured to enforce a security policy on Computing Network 100, optionally responsive to a security audit. This security policy may be managed by PVS 110 and may include the execution of security audits on devices connected to Computing Network 100. DPEP 120 and DPEP 130 are established as DPEPs by the addition of software to a server, personal computer, or other general computing device having software execution capabilities. Thus, DPEP 120 and DPEP 130 can be non-dedicated devices that are also configured to perform computing functions, such as file storage, e-mail, word processing, or the like, not directly related to network security. DPEP 120 and DPEP 130 are configured to communicate with each other using MAC addresses, ARP, and/or other physical device addressing systems. Thus, DPEP 120 and DPEP 130 are typically on the same network segment, virtual local area network, or the like.

Each of DPEP 120 and DPEP 130 is configured to function as an APEP when needed. In some embodiments, only one DPEP 120 and DPEP 130 will function as an APEP at a time for any specific device. At different times, each of DPEP 120 and DPEP 130 may function as the APEP. For example, if DPEP 120 is functioning as the APEP and then becomes disconnected from Computing Network 100, DPEP 130 may automatically begin to function as the APEP. Thus, the APEP can be changed dynamically from DPEP 120 to DPEP 130 without changing configuration settings of the computing network. Typically, there will be one APEP on each secured network segment. In some embodiments, each DPEP (e.g., DPEP 120 and DPEP 130) keeps track of which DPEP on a network segment is operating as the APEP at any given time. In some embodiments, PVS 110 keeps track of which DPEP is operating as the APEP on each network segment. As discussed elsewhere herein, in some embodiments, one, several or all DPEPs may function as APEPs simultaneously.

In some embodiments, PFC 180 is included in DPEP 120 and/or DPEP 130. Thus, an APEP can be configured to redirect network packets to itself. In these embodiments, the APEP both enforces the security policy by causing redirection and acts as an intermediary between devices on Computing Network 100. Computing Network 100 optionally includes more than one PFC. In those embodiments wherein PFC 180 is included in DPEP 120, DPEP 130, or some general purpose computing device, PFC 180 typically includes logic configured for differentiating between received packets addressed to PFC 180 and intended for some other device, and received packets addressed to PFC 180 and intended for PFC 180. Thus, PFC 180 may accept packets intended for itself and modify, drop or forward packets intended for some other device.

PFC 180 receives redirected communications sent from a first device to a second device on Computing Network 100. PFC 180, thus, acts as an intermediary between the first and the second device. As used herein, the term intermediary is not meant to imply the PFC 180 necessarily forwards redirected packets that it receives. If the first device and/or the second device have not satisfied the requirements of a security policy, then the intercepted communication is typically not forwarded to its intended destination. If the requirements of the security policy have been satisfied by the first or second devices, then the intercepted communication may be forwarded to its intended destination. Thus, PFC 180 may function as an intermediary between the first device and the second device. Further, in some embodiments, if previously unmet requirements become met, then the APEP may end the redirection of communications. In these instances, the APEP removes PFC 180 from its position as an intermediary and allows direct communication between the first and second devices.

In some embodiments, the APEP is configured to establish PFC 180 as an intermediary between the first and second devices by monitoring for an ARP request from the first device (or any unauthorized device). If such an ARP request is detected, then in response the APEP is configured to send an ARP response to the first device falsely indicating that the APEP is the second device. Typically, this false ARP response includes the MAC address of the PFC in association with an IP address of the second device. In some embodiments, more than one false resolution protocol response is sent by the APEP in response to each ARP request. Typically, the APEP will respond in a similar fashion to the detection of an ARP request from any unauthorized device.

In some embodiments, the APEP is configured to establish PFC 180 as an intermediary between the first and second devices by periodically sending ARP responses, without necessarily having received a corresponding ARP request. These ARP responses may be sent to an unauthorized device in order to redirect network packets sent by the unauthorized device to PFC 180. These ARP responses may also be sent to a secure device on Computing Network 100 with which the unauthorized device is attempting to communicate. In this case, the ARP responses are configured to falsely indicate to the secure device that the MAC address of PFC 180 is the MAC address of the unauthorized device. Thus, communication from the secure device to the unauthorized device will be redirected to PFC 180.

In some embodiments, ARP responses are sent to authorized devices with which unauthorized devices attempt to communicate, or to authorized devices which are attempting to communicate with unauthorized devices. This results in the redirection of traffic from the secure device intended for unauthorized device. In some embodiments, ARP responses are sent do both unauthorized devices and secure devices with which unauthorized devices attempt to communicate. Thus, PFC 180 can be established as an intermediary between the secure and unauthorized devices with regards to both directions of communications. These ARP responses can be sent periodically and/or in response to an ARP request.

In some embodiments, the APEP is configured to establish PFC 180 as an intermediary between the devices by using ARP requests instead of or in addition to ARP responses. Because many devices will update their MAC address and IP address records in response to either a detected ARP request or a detected ARP response, ARP requests can be used instead of or in addition to ARP responses as describe herein. For example, in one embodiment, the APEP is configured to redirect communications by sending one or more ARP response in response to an ARP request received from an unauthorized device and also to send periodic ARP requests to a secure device with which the unauthorized device attempted to communicate. These ARP requests falsely associate the MAC address of PFC 180 with the IP address of the unauthorized device. In one embodiment, the APEP is configured to monitor for ARP requests from unauthorized devices and when such a request is received to determine the device to which the request is intended. The APEP will then send periodic ARP requests to the intended device. These ARP requests are configured to redirect future communications sent by the intended device, such that these communications will not be received by the unauthorized device. Various embodiments of the invention include the further possible combinations of ARP requests, ARP responses, redirection of secure device output, redirection of unauthorized device output, periodic ARP messages, and ARP messages sent in response to an action by the unauthorized device.

Typically, each APEP tracks which devices on a segment of Computing Network 100 have or have not satisfied the requirements of a security policy. Each DPEP and/or APEP is typically configured to maintain a list of other DPEPs and APEPs on the same network segment. This list is referred to herein as a friends list. Friends List 250 is an example of this list. Friends List 250 is optionally maintained through various methods, including, for example: (i) periodically sending a specially crafted message to other devices to verify membership in the friend list, where the specially crafted message is optionally signed or encrypted by an object (e.g. token, certificate, or key) which can only be obtained after passing a security audit), (ii) obtaining friend information from a remote server (e.g. PVS 110, an LDAP server, MS Active Directory Server, or the like) or from a locally stored list (e.g. file, registry, memory), such information allowing determination of friend addresses, (iii) obtaining information about endpoints which are not friends, such information allowing determination of non-friend addresses, (iv) using an authentication protocol or key exchange protocol (e.g. IPSec IKE, SSL/TLS, Kerberos, or the like) to communicate with other endpoints to determine which peers are friends, (v) using a protocol involving a central server (e.g. PVS 110, a LDAP server, an MS Active Directory Server, or the like) to obtain tokens, keys or certificates that can decrypt traffic or messages from other endpoints to determine which endpoints are friends, (vi) any of the preceding methods used in combination, or the like. For example, some embodiments may consider any device that is not on a white list and has not passed an audit to be unauthorized. In some embodiments, some or all tracking of friends is performed by either another DPEP or a trusted endpoint, and the information is provided for use by the APEP. In some embodiments, the DPEP uses the friend list, which optionally contains the MAC address and IP address for each device in the list, to manage the destination MAC address for outbound packets to IP addresses to ensure the destination MAC and destination IP addresses are consistent with the list, optionally changing the ARP cache of the DPEP, destination MAC address of the packet, or dropping to the packet to prevent an unauthorized device from falsely redirecting DPEP packets to an unintended device.

In some embodiments, DPEP 120 and DPEP 130 include logic configured for use in determining which, if either, of DPEP 120 and DPEP 130 is the current APEP at any particular time. This logic is optionally also configured for determining which DPEP should become the new APEP if a current APEP becomes unavailable. In alternative embodiments, PVS 110 includes the logic for determining which DPEP should become the new APEP. The new APEP is selected from a list of DPEPs on the network segment, e.g., Friends List 250. In some embodiments, two, three or more APEP may be active on the same network segment. Thus, multiple DPEPs on the same network segment may operate as APEPs at the same time. In some embodiments, all DPEPs on a network segment operate as APEPs at the same time.

The selection of a new APEP from more than one DPEP may be based on a variety of factors, optionally related to security. For example, the selection of a DPEP may be dependent on a device type, e.g., a server may be preferred over a personal computer or a mobile device. In some embodiments, the selection of an APEP is dependant on a type of security audit that has been applied to the device. For example, a device having satisfied a more rigorous security audit may be preferred over a device having satisfied a less rigorous security audit. In some embodiments, the selection of an APEP is dependent on a user of a device. For example, if a user with a higher security clearance has logged into a first DPEP and a user with a lower security clearance has logged into a second DPEP, then the first DPEP may be preferred when selecting an APEP.

In various embodiments, the selection of an APEP is dependent on device usage, device communication capacity, and/or processing power. For example, a device with greater processing power, greater communication bandwidth or lower non-security usage may be preferred over a device with less processing power, etc. In some embodiments, selection of an APEP is dependant on whether a device is permanently or temporally connected to a network segment. For example, a file server physically connected to the network at a central server location may be preferred over a mobile device temporally connected to the network via a wireless link.

Typically, an APEP will communicate to all other DPEPs on a periodic basis. This communication can include a list (e.g., Friends List 250) of all qualified DPEPs on the network segment. Optionally, this list includes the MAC address of each of these devices. This list may be maintained as Friends List 250 by having each of the DPEPs periodically communicate to the current APEP. If a Friends List 250 related message is not received from the APEP within a predetermined time period, the DPEPs will assume that the APEP has been disconnected from the network segment. In some embodiments, when this occurs the DPEPs will then cooperate to select a new APEP from among themselves, e.g., from among the most recent friends list of DPEPs. This selection may be based on criteria discussed elsewhere herein. In alternative embodiments, PVS 110 is used to select a new APEP. In some embodiments, the APEP and/or each of the DPEPs are configured to maintain a list of MAC addresses associated with devices that have passed the security audit and to prevent spoofing of these MAC addresses.

As discussed elsewhere herein, the APEP is configured to prevent communication from and/or to an unauthorized device to other devices on Computing Network 100. For example, if Device 140 is a device that has not satisfied requirements of a security audit and DPEP 130 is a current APEP, then DPEP 130 may prevent Device 140 from communicating directly with DPEP 120 and/or Router 160. Typically, direct communication is prevented by persuading Device 140 that the MAC address (or other physical address) of DPEP 130 (the APEP) is the MAC address of DPEP 120 or Router 160.

When Device 140 broadcasts an ARP request to other devices on the same network segment, this request includes the MAC address of Device 140. The MAC address of Device 140 can be compared, by the APEP, with the list of devices that have satisfied the requirements of the security policy. Through this comparison, the APEP can determine whether or not Device 140 has satisfied the requirement of the security policy.

If Device 140 has not satisfied the requirements of the security policy, then the APEP (DPEP 130) may respond to the ARP request, even though the request was not intended for DPEP 130. The response from DPEP 130 will include the MAC address of PFC 180 falsely identified as being the MAC address of the intended recipient of the ARP request, e.g., DPEP 120 or Router 160. If Device 140 accepts this ARP response, then further communication to DPEP 120 or Router 160 from Device 140 will make use of the MAC address included in the ARP response and, thus, be directed to PFC 180. In some embodiments, the APEP will send more than one ARP response in response to a single ARP request. This may increase the chance that Device 140 will accept the ARP response sent by DPEP 130 rather than any ARP response sent by the intended recipient of the ARP request. By spoofing the physical address of the intended recipient of the ARP request, the APEP can place itself as an intermediary between the unauthorized device and the intended target of the communication. As described elsewhere herein, the APEP may also (or alternatively) send an ARP message to DPEP 120 or Router 160 in order to prevent them from communicating to the unauthorized device.

In some embodiments, a security audit includes qualification of a device, if possible, as a DPEP. For example, a security audit can include downloading of software to the device configured to enable the device as a DPEP. As such, the number of DPEPs on a computing network automatically scales with the number of devices on the computing network. In addition, security on the computing network is self-configuring. For example, once a single DPEP is established on a network segment, all other devices on that network segment are forced to satisfy requirements of the security policy and may themselves become DPEPs. Any device attempting to communicate to a device on a segment including a DPEP may be forced to comply with a security policy. This can be the case regardless of whether the device is on the same network segment or not. The security of the computing network is, therefore, self configuring.

In a few circumstances, a device may not be configurable as a DPEP. For example, if a device is an unsecured, wireless device with significantly limited communication bandwidth, it may be able to pass minimum requirements of a first level of a security policy including several levels, but not be configurable as a DPEP. In some embodiments, all devices that have satisfied the requirements of the security policy are qualified as DPEPs.

In some embodiments, it may not be possible to apply a security audit to a device. For example, a printer may not be able to execute an agent required for the security audit. In these instances, the security policy may include a “white list” of authorized devices, wherein the white list contains information or rules sufficient to allow determination of whether an address is in the white list. In some embodiments, the white list may contain information that determines which network services are permitted without a security audit. In some embodiments, the white list may contain information that determines which servers can be communicated with, even by unauthorized devices.

PVS 110 is typically configured to manage the security policy of Computing Network 100, optionally to manage security audits of devices on Computing Network 100. As illustrated in FIG. 1B, PVS 110 is optionally on a different network segment than a device whose security PVS 110 manages. In some embodiments, the attributes of PVS 110 are distributed among several different computing devices, optionally on different network segments. Further embodiments of PVS 110, security audits, and the application of a security policy can be found in U.S. patent application Ser. Nos. 11/227,679 and 10/949,179, the disclosures of which are hereby incorporated by reference for these purposes.

In some embodiments, a DPEP can redirect a web request by Device 140 to a software download site. This software, when installed, can enable Device 140 to operate as a DPEP as described herein. Thus, in some embodiments, when a device is added to Computing Network 100, the DPEP automatically directs the device to a site to download software which makes it become a DPEP. The location of the download site is optionally associated or managed by PVS 110. This redirection is optionally enabled and disabled dependent on the result of a security audit.

In some embodiments, PVS 110 is distributed in a hierarchical nature. For example, a central server may be used to manage the overall system while a local server may be used to manage those attributes related to the local network. In one embodiment, a central server is configured for defining the requirements of a security audit, while a local server is configured for maintaining a white list of authorized devices. In one embodiment, a local server is configured to define a range of addresses within a network segment related to devices that are assumed to be secure and/or define a range of addresses within a network segment that must pass a security audit. Thus, a white list can be defined as a group of addresses, address ranges, or addresses defined by certain patterns (e.g. MAC addresses from the same manufacturer and with the same purpose often have the same prefix, such as printer MAC address ranges) where the address can be a MAC address or IP address. The defined address ranges can be different for different network segments, or other divisions of Computing Network 100. Both the central server and local server may be considered part of PVS 110.

Device 140 is a device that may be configured as a DPEP. For example, Device 140 can be a general computing device such as a server, personal computer, mobile device, notebook computer, or the like. Typically, Device 140 is not a dedicated security device and is configurable as a DPEP by loading of appropriate software.

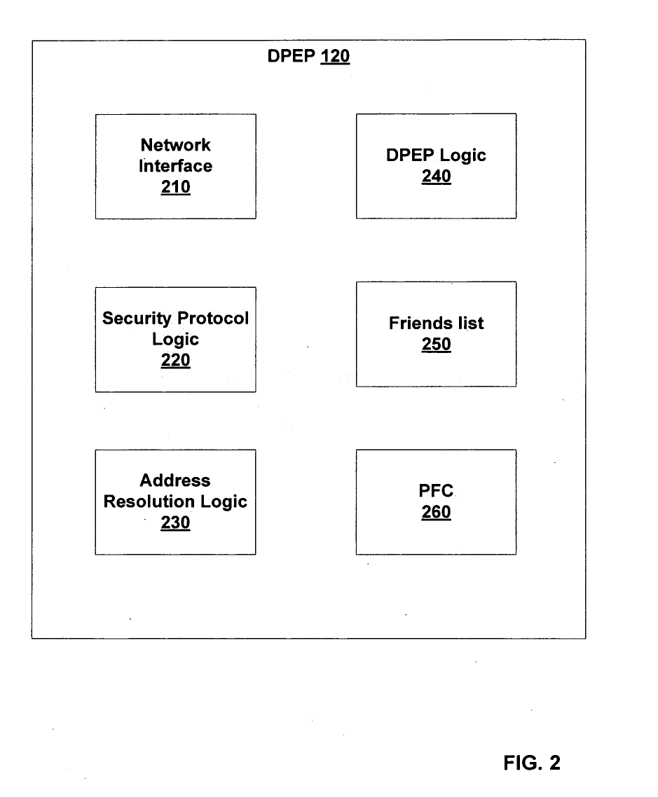

FIG. 2 illustrates further details of DPEP 120, according to various embodiment of the invention. DPEP 120 includes a Network Interface 210, an optional Security Protocol Logic 220, an address Resolution Logic 230, DPEP Logic 240, an optional Friends List 250, and an optional PFC 260. Network Interface 210 is configured for communication between DPEP 120 and other elements of Computing Interface 100. For example, in some embodiments, Network Interface 210 includes an Ethernet interface.

Security Protocol Logic 220 is configured to assure that Device 140, or any other device attached to Computing Network 100, satisfies the requirements of a network security protocol. For example, Security Protocol Logic 220 may be configured to assure that Device 140 meets the requirements of a security protocol enforce by PVS 110. In various embodiments, Security Protocol Logic 220 includes a firewall, anti-virus logic, or the like. In some embodiments, Security Protocol Logic 220 includes an agent running on Device 140 configured to perform a security audit and assure that Device 140 continues to satisfy the requirement of the network security protocol. If Device 140 initially satisfies the requirements of the security policy, but changes such that these requirements are no longer satisfied, then Security Protocol Logic 220 may notify PVS 110. PVS 110 may then notify an APEP, which will communicate to Device 140 and/or devices communicating with Device 140 in an effort to prevent further communication to or from parts of Computing Network 100 from or to Device 140. This effort may include, for example, the MAC address spoofing described above (e.g., sending false ARP messages), a denial of service attack, and/or the like. In some embodiments, Security Protocol Logic 220 checks Device 140 ports by using protocols like TCP or UDP scans, or Windows WMI communications to check for vulnerabilities or exploits, which if present, would cause Device 140 to fail security policy and become unauthorized. This approach does not require any additional software to be installed on the Device 140 to assess whether it is authorized or unauthorized. Being unauthorized would, typically, cause an APEP to restrict communications to and from Device 140.

Resolution Logic 230 is configured to detect messages to learn about authorized and unauthorized devices on the network, and generate messages, as described elsewhere herein, in order to limit communications to or from unauthorized devices. For example, in some embodiments, Resolution Logic 230 is configured to monitor Computing Network 100 for ARP requests and/or DHCP requests from devices on Computing Network 100, and to send out an appropriate response via Network Interface 210, if the devices are unauthorized. In some embodiments, unauthorized devices are identified because some combination of MAC addresses and/or IP address are not included on a list of devices that have satisfied the requirements of the security policy. The response typically includes a false representation that the address of DPEP 120 is the MAC address of a device for which the ARP request was intended. In some embodiments, Resolution Logic 230 is configured to send periodic ARP messages to unauthorized devices and/or secured devices with which unauthorized devices attempt to communicate.

DPEP Logic 240 is configured for monitoring which DPEPs are the current APEPs, monitoring the status of the current APEPs, and determining a new APEP if an APEP becomes unavailable.

In some embodiments, DPEP Logic 240 makes use of Friends List 250 to monitor which devices on Computing Network 100 have passed the security policy, and/or which devices on Computing Network 100 are DPEPs. Friends List 250 is optionally similar to a friends list typically maintained by a network firewall. Friends List 250 is typically communicated between DPEPs on Computing Network 100.

PFC 260 is configured to receive and optionally forward redirected communications as described elsewhere herein. Computing System 100 and/or a particular network segment may include more than one PFC 260. For example, an APEP may be configured to distribute the load of redirected communications among several different PFC 160. PFC 260 is optionally included within DPEP 120 and/or DPEP 130. In some embodiments, each DPEP includes an instance of PFC 160 and the DPEPs share the redirected communication load.

The various logic illustrated in FIG. 2 can include software, firmware, and/or hardware.

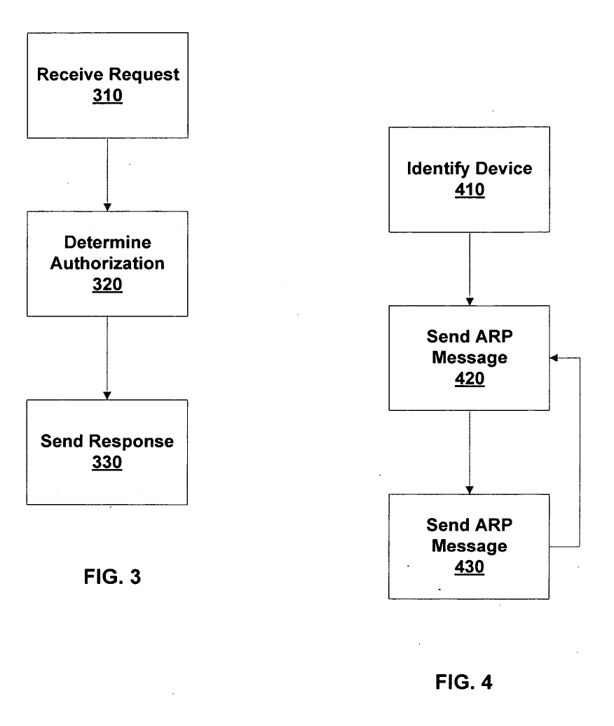

FIG. 3 illustrates a method of providing dynamic security to a computing network, according to various embodiments of the invention. The method of FIG. 3 may be performed by an APEP as part of enforcing a security policy. In a Receive Request Step 310, the APEP receives an ARP request. This request is typically received from a device on a local network segment. For example, the request may be received from a Device 140 or Router 160. As described elsewhere herein, the ARP request includes a MAC address of the device making the request and an IP address of an intended recipient. Typically, the ARP request is broadcast to all devices on the network segment.

In a Determine Authorization Step 320, the APEP determines if the ARP request received in Receive Request Step 310 is from a device that has satisfied requirements of a security policy, a device on a white list, or from an unauthorized device. This determination is optionally made by comparing either or both the MAC address and IP address of the sender of the request with a list of addresses (e.g., Friends List 250) of devices that have satisfied the requirements. If the request if from a device that has satisfied the requirements, then the APEP typically ignores the request. If the sender of the ARP request is an unauthorized device, then the APEP responds in a Send Response Step 330.

In Send Response Step 330, the APEP sends one or more ARP responses (or ARP requests) to the sender of the ARP request. As discussed elsewhere herein, this response is configured to falsely identify the PFC 180 as the intended recipient of the ARP request. In some embodiments, the response includes the MAC address of PFC 180 falsely associated with an IP address of the intended recipient. In alternative embodiments, the APEP may take other steps to prevent the unauthorized device from communicating with other devices on the network segment. For example, the APEP and/or other DPEPs may, send ARP messages to the intended recipient of the ARP request received in Receive Request Step 310, or manage a denial of service attack on the unauthorized device.

In some embodiments, Send Response Step 330 further includes communicating from the APEP to PVS 110. This communication may include the identity of the unauthorized device and be configured to allow PVS 110 to communicate with the unauthorized device for the purposes of downloading security software or notifying administrators.

FIG. 4 illustrates another method of providing dynamic security to a computing network, according to various embodiments of the invention. In these embodiments, ARP messages are periodically sent by the APEP. These ARP messages are not necessarily in response to an ARP message received by the APEP. In an Identify Device Step 410, the APEP identifies an unauthorized device. In a Send ARP Message Step 420, the APEP sends a first ARP message configured to control communication to or from the unauthorized device identified in Identify Device Step 410. This message can be an ARP request or an ARP response. This message can be sent to the unauthorized device or to a secure device to which the unauthorized device was attempting to communicate. In a Send ARP Message Step 430, the APEP sends out a second ARP message configured to control communication to or from the unauthorized device. Steps 420 and 430 are optionally repeated periodically, for as long as the redirection of the unauthorized device is required.

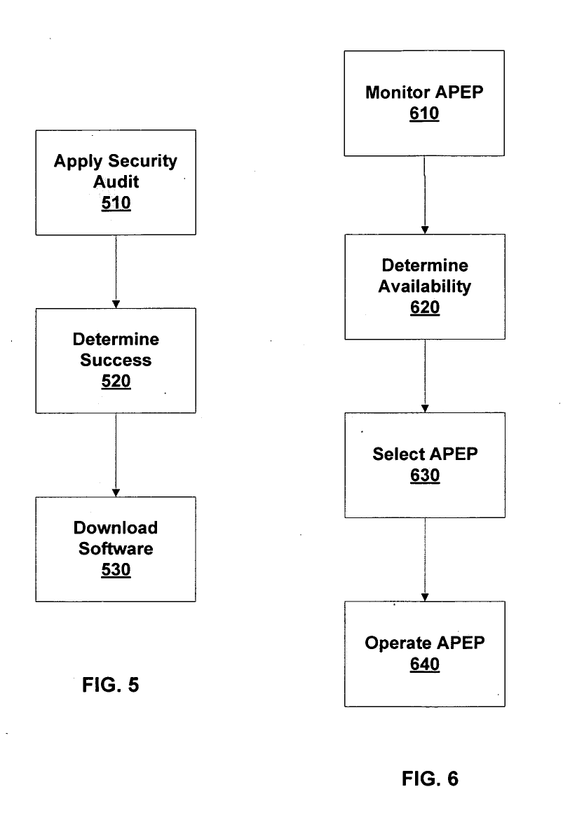

FIG. 5 illustrates a method of generating a DPEP, according to various embodiments of the invention. In some embodiments, this method is managed by PFC 180, for example, by redirecting network traffic (e.g. modifying the destination address) or responding to device requests (e.g. where the PFC intercepts a DNS query by a device and responds with a server address) causing traffic to be directed to a server containing software which can be installed on devices. In some embodiments, the method of FIG. 5 is managed by PVS 110 by loading logic into a general computing device (e.g. using Windows WMI to install software or commanding an agent on the device to install software), for example, in Send Response Step 330, or in response to receiving the identity of an authorized device that is not yet a DPEP. In some embodiments, DPEPs are generated automatically as needed. In some embodiments, any device that passes a security audit is automatically configured as a DPEP if the device qualifies as such (e.g., has the required processing and communication components).

In an optional Apply Security Audit Step 510, PVS 110 is used to apply a security audit to an unauthorized device, such as Device 140. The security audit is optionally facilitated by an agent downloaded to the unauthorized device. In some embodiments, the security audit can apply several different levels of security requirements. Those devices that satisfy the requirements of lower levels will be given a lower security clearance (authorization), and those device that satisfy the requirement of higher levels will be given a higher security clearance. In some embodiments, the level of security clearance is used to determine which devices on Computing Network 100 can be accessed. Thus, an APEP may manage multiple friends lists, each associated with a different security level. Further details of security audits can be found in U.S. patent application Ser. Nos. 11/227,679 and 10/949,179.

In an optional Determine Success Step 520, the success of the security audit applied in Apply Security Audit Step 510 is determined. If the audit is successful then the previously unauthorized device is now authorized to access other devices on Computing Network 100. In addition, by successfully passing the security audit a device may become qualified as a potential DPEP. In some embodiments, a first level of security clearance is required for accessing other devices on Computing Network 100 and a second level of security clearance is required for becoming a DPEP. In some embodiments, a first level of security clearance is required for accessing devices on a local network segment and a second level of security clearance is required for accessing device elsewhere in Computing Network 100. These different levels of security are optionally managed by different (e.g., local and central) parts of PVS 110.

In a Download Software Step 530, software is downloaded to the device to optionally make it a DPEP, to remediate a non-compliant configuration, or to run an agent to permit a security audit to take place. This download is optionally managed by PVS 110, APEP, or PFC 180 and includes software configured for making the recipient a DPEP. For example, in some embodiments, the downloaded software includes Security Protocol Logic 220, Address Resolution Logic 230 and DPEP Logic 240 as illustrated in FIG. 2. In some embodiments, the downloaded software includes just the audit agent software to allow the device to participate in a client-based security audit.

In some embodiments, passing the security audit of Step 510 is not required for a device to become a DPEP. For example, Step 530 may include downloading of software to configure a device as a DPEP and also to perform the security audit. Thus, the device receives software for configuration as a DPEP at approximately the same time that it receives an agent for performing a security audit. The steps of FIG. 5 may be performed in different orders. However, passing of a security audit is typically required in order for a DPEP to start functioning as an APEP.

In some embodiments, the steps illustrated in FIG. 5 are performed automatically responsive to an attempt by an unauthorized device to communicate with protected parts of Computing Network 100. In these embodiments, the security of Computing Network 100 is self-configuring. The number of DPEPs automatically scale with the number of devices on the computing network. Security is enforced in a peer-to-peer relationship between network devices. This is accomplished without manually updating or configuring switches, routers, gateways, DHCP servers, or other network control systems.

FIG. 6 illustrates a method of selecting an APEP, according to various embodiments of the invention. In this method, one or more APEPs are selected from the group of DPEPs. The method may be used after a previous APEP becomes disconnected from the network or if the previous APEP stops running the DPEP software. Typically, the method illustrated in FIG. 6 is automatic.

In a Monitor APEP Step 610, one or more DPEPs on a network segment monitor the status of an APEP. This monitoring is typically accomplished by receiving communication from the APEP on a periodic basis. This communication optionally includes a list (e.g., a MAC address list or friends list) of the DPEPs on the same network segment.

In a Determine Availability Step 620 it is determined that the APEP monitored in Monitor APEP Step 610 is no longer operating properly as an APEP. This may occur, for example, if the monitored APEP is removed from the network segment. In some embodiments, the determination is made by observing that the periodic communication has not been received from the APEP for a period of time. A time stamp or updated counter may be included in the communication to prevent a replay by an unauthorized device, and the communication may be signed to prevent forgery by an authorized device.

In a Select APEP Step 630, a new APEP is selected from among the one or more DPEPs remaining on the network segment. Examples, of criteria that can be used for making this selection are discussed elsewhere herein. If only one DPEP remains on the network segment, then this DPEP automatically becomes the new APEP. If more than one DPEP remain on the network segment, then these DPEPs optionally cooperate in determining the new APEPs. In some embodiments, PVS 110 is used in selecting the APEPs. The number of APEPs may be specified by configuration settings, and may range from none to the number of DPEPs. The configuration settings may be provided configured locally on the DPEP or provided by the PVS.

In an Operate APEP Step 640, the new APEP selected in Select APEP Step 630 is operated as an APEP. For example, the selected APEP may perform one or both of the methods illustrated by FIG. 3 and FIG. 4.

Several embodiments are specifically illustrated and/or described herein. However, it will be appreciated that modifications and variations are covered by the above teachings and within the scope of the appended claims without departing from the spirit and intended scope thereof. For example, some embodiments of the invention include computer readable media having stored thereupon computer code configured to perform the methods disclosed herein. For example, the network segments discussed herein are alternatively VLANs (virtual local area networks) or any other subset of a computing network in which communication between devices is based on layer 2 addresses, e.g., MAC addresses.

Computing Network 100 optionally includes part of a telecommunications or wireless network. The systems and methods discussed herein are optionally configured to manage and automatically scale multiple security layers and security clearance levels. In some embodiments, an APEP is configured to prevent an unauthorized device from communicating through the use of a denial of service attack. In some embodiments, an unauthorized device may be allowed to communicate to a non-secured part of Computing Network 110 but not to a secured part of Computing Network 110. For example, Device 140 may be permitted to communicate with Gateway 110 and/or a printer prior to satisfying the requirements of a security policy, but not permitted to communicate with DPEP 120 or Router 160. The communication to Gateway 110 is optionally for the purpose of requesting a security audit and becoming authorized, and/or downloading software for configuring a DPEP.

While the examples discussed herein are primarily focused on the use of ARP messages, Neighbor Discovery Protocol messages in IPv6, DHCP messages, and DNS messages may be used instead of or in addition to ARP messages in alternative embodiments even when the redirection is occurring at a higher layer of the network.

In some embodiments, the systems and methods described herein are just to control communication between routers or routing devices on a computing network. For example, the methods may be used to control communication between a VPN device and a router. In such an embodiment, the APEP intercepts traffic between two routers or between a VPN concentrator and a router, or between a VPN concentrator and a network, and performs filtering and forwarding of the packets between them. This technique is similar to intercepting traffic between a device and router, except the device is a router or VPN concentrator instead of an endpoint.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

What is claimed is:

1. A computing network comprising:
a server configured to download logic to a non-dedicated, general purpose computing devices, the logic being configured to allow the general purpose computing device to operate as a DPEP;
a PFC configured to receive packets sent by unauthorized devices or to receive packets sent to unauthorized devices, the PFC being further configured to modify, drop or forward the received packets;
a first PVS configured to manage a security audit to determine whether a device is an unauthorized device by comparing a security policy to information about the device; and
a first DPEP and a second DPEP on the same network segment, the first DPEP and second DPEP each being general purpose computing devices and being configured to function as an APEP, and to enforce the security policy responsive to the security audit by sending an ARP message to redirect communication, between an unauthorized device and an other device, to the PFC, the first DPEP and the second DPEP each including logic configured for repeatedly determining if either of the first DPEP and second DPEP is an APEP.

2. The computing network of claim 1, wherein the first PVS is not included in the first DPEP or the second DPEP.

3. The computing network of claim 1, further including a second PFC configured to receive packets sent by unauthorized devices or to receive packets sent to unauthorized devices.

4. The computing network of claim 1, wherein the PFC is included in the DPEP.

5. The computing network of claim 1, further including a rule server configured to provide rules to the first PVS, the rules being for use in determining if a packet will be modified, dropped, or forwarded.

6. The computing network of claim 5, wherein the first PVS is included in the DPEP.

7. The computing network of claim 1, wherein the PFC is not included in the APEP.

8. The computing network of claim 1, wherein the first PVS is further configured to configure a device on the computing network as a DPEP by downloading and installing software to the device.

9. The computing network of claim 1, wherein the PFC is configured to redirect network requests to a software download site, the software download site including software configured to configure the device as a DPEP or to enable the device to participate in a security audit.

10. The computing network of claim 1, wherein a number of DPEPs increases automatically when more devices are added to the computing network, up to a number of general computing devices on the network.

11. The computing network of claim 1, wherein a number of APEPs can range from one up to a number of DPEPs.

12. The computing network of claim 11, wherein the first DPEP is configured to automatically start to function as an APEP when an existing APEP is removed from the computing network, logic configured to start the first DPEP functioning as an APEP being included in the first DPEP.

13. The computing network of claim 1, wherein the logic is configured to use a list of devices that have passed the security audit to determine the APEP.

14. The computing network of claim 1, wherein the first DPEP and the second DPEP are configured to exchange a list of DPEPs.

15. The computing network of claim 1, wherein whether or not the first DPEP is an APEP is responsive to factors relating to security.

16. The computing network of claim 1, wherein selection of the APEP or the configuration parameters used in the selection of the APEP is managed by a PVS.

17. The computing network of claim 1, wherein a security status of a device on the computing network is tracked using a MAC or IP address of the device.

18. The computing network of claim 1, wherein the first DPEP is further configured to maintain a list of MAC and IP address combinations associated with devices that have passed the security audit.

19. The computing network of claim 18, wherein the first DPEP is configured to use the list of MAC and IP address combinations to manage a destination MAC address for a packet sent to an IP address, to determine if the IP address is within the list of MAC and IP address combinations, and if the IP address is within the list to determine if the destination MAC address of the packet matches a MAC address associated with the IP address in the list, and if the destination MAC address does not match either dropping the packet or changing the destination MAC address.

20. The computing network of claim 18, wherein the first DPEP is configured to use the list of MAC and IP address combinations to assure that an ARP cache of the first DPEP is not inconsistent with the list of MAC and IP address combinations.

21. The computing network of claim 1, wherein neither the first DPEP nor the other DPEPs are dedicated security devices.

22. The computing network of claim 1, wherein essentially any personal computer, notebook computer, or server on the computing network is a potential DPEP.

23. The computing network of claim 1, wherein both the first DPEP and the second DPEP are configured to track, in parallel, which devices on the network segment have passed the security audit.

24. The computing network of claim 1, wherein the APEP is configured to prevent a device that has not passed the security audit from communicating with parts of the computing network.

25. The computing network of claim 1, wherein the first DPEP is configured to prevent a device on the network from communicating with the unauthorized device.

26. The computing network of claim 1, further including a third DPEP on the same network segment as the first DPEP and the second DPEP, the third DPEP being a peer of the first DPEP and the second DPEP.

27. A computing network comprising:
a server configured to download logic to a non-dedicated, general purpose computing devices, the logic being configured to allow the general purpose computing device to operate as a DPEP;
a plurality of PFC configured to receive packets sent by unauthorized devices or to receive packets sent to unauthorized devices, the plurality of PFC being further configured to modify, drop or forward the received packets;
a first DPEP, a second DPEP and a third DPEP on the same network segment, the first DPEP, second DPEP and third DPEP each configured to function as an APEP, and to enforce a security policy responsive to a security audit by sending an ARP message to redirect communication, between an unauthorized device and an other device, to the PFC; and
a first PVS configured to manage the security audit to determine whether a device is an unauthorized device by comparing the security policy to information about the device, the first PVS being included in either the first DPEP or the second DPEP.

28. The computing network of claim 27, wherein at least two of the first DPEP, second DPEP and third DPEP are configured to function as an APEP at the same time.

29. The computing network of claim 27, wherein the first DPEP, second DPEP and third DPEP are each general purpose computing devices.

30. The computing network of claim 27, wherein the first DPEP, second DPEP and third DPEP include at least two different device types.

31. A computing network comprising:
a server configured to download logic to a non-dedicated, general purpose computing devices, the logic being configured to allow the general purpose computing device to operate as a DPEP;
a plurality of PFC configured to receive packets sent by unauthorized devices or to receive packets sent to unauthorized devices, the plurality of PFC being further configured to modify, drop or forward the received packets; and
a PVS configured to manage a security audit to determine whether a device is an unauthorized device by comparing a security policy to information about the device;
a first DPEP and a second DPEP on the same network segment, the first DPEP and second DPEP each being general purpose computing devices and being configured to function as an APEP, and to enforce the security policy responsive to the security audit by sending an ARP message to redirect communication, between an unauthorized device and an other device, to the PFC; and
a rule server configured to provide rules to the plurality of PFC for use in determining if a packet should be modified, dropped, or forwarded.

32. The computing network of claim 31, wherein the plurality of PFC are included in the first DPEP and the second DPEP.

33. The computing network of claim 31, further including a third DPEP on the same network segment as the first DPEP, the third DPEP being configured to function as an APEP, and to enforce the security policy responsive to the security audit by sending an ARP message to redirect communication.

34. The computing network of claim 31, wherein each of the plurality of PFC are configured to differentiate between packets intended for themselves or intended for other devices.
